(19) United States
(12) Patent Application Publication
(10) Pub. No.: US 2005/0089651 A1
(43) Pub. Date: Apr. 28, 2005

(54) Method for producing coated paper for printing

(76) Inventors: Koji Okomori, Tokyo (JP); Masato Yamaguchi, Tokyo (JP); Masahito Suzuki, Tokyo (JP); Hirokazu Morii, Tokyo (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/501,399

(22) PCT Filed: Jan. 16, 2003
(86) PCT No.: PCT/JP03/00314

(30) Foreign Application Priority Data
Jan. 16, 2002 (JP) 2002-6829
Mar. 29, 2002 (JP) 2002-197006
Aug. 8, 2002 (JP) 2002-230896

(51) Int. Cl. B05D 3/12; B41M 5/00

(52) U.S. Cl. 428/32.34; 427/361

(57) ABSTRACT

The present invention provides a method for producing coated papers for printing having good coating ruunability during film transfer coating, good print gloss and ink density and excellent printability, and also provides the resulting coated papers.

Disclosed is a method for producing a coated paper for offset printing or gravure printing by applying a coating color containing a pigment and an adhesive on a base paper, wherein the coating color containing 0.1 parts by weight or more and less than 2.0 parts by weight of polyvinyl alcohol (PVA) per 100 parts by weight of the pigment is applied by the film transfer method and preferably the coating weight per side is 7 g/m² or more. For coated papers for web offset printing, the coating color contains less than 2.0 parts by weight of a starch as an adhesive.

### TECHNICAL FIELD

The present invention relates to a method for producing coated papers for printing with excellent printability by the film transfer coating and the resulting coated papers.

### PRIOR ART

In recent years there have been strong demands for sending a visually impressive message (hereinafter referred to as ‘visualization’) by using many photographs or graphics in color on printed papers such as coated papers for offset printing or coated papers for gravure printing. On the other hand, on-machine coaters consisting of an integrated combination of a paper machine and a coater are widely used to efficiently prepare coated papers at a low cost. Coating methods using on-machine coaters mainly include film transfer coating and blade coating. Film transfer coating involves transferring a metered coating color on an applicator roll onto a base paper and has the advantage that web breake and other troubles during coating are less likely to occur because the load on the base paper during coating is relatively lower than applied by blade coating. However, film transfer coating has the disadvantages that it entails more difficulty in attaining high coating weight as compared with blade coating and the coating color untransferred to the base paper scatters during coating (hereinafter referred to as ‘mist’) because of the limited transferability of the coating color on the applicator roll to the base paper. To prepare coated papers for offset printing or the like at a grade well-suitable for visualization, the coating weight must be generally increased. However, it is difficult to increase the coating weight by film transfer coating, and therefore, it is difficult to achieve visualization and high efficiency simultaneously in the present circumstances.

In order to produce coated papers at a grade well-suited for visualization with decreased missing dots in gravure printing, the coating weight must also be increased. However, it is difficult to increase the coating weight by film transfer coating, and therefore, it is difficult to achieve visualization and high efficiency simultaneously in the present circumstances.

Generally, coated papers are roughly classified into gloss grade and matte grade. Gloss grade includes art papers, super art papers and gloss coated papers that have been used for high-grade printing and provide gloss-type finished prints in which both sheet gloss and print gloss are high. Matte grade provide dull grade and matt grade depending on the sheet gloss and the print gloss. Matt grade has low sheet and print gloss to give a flat and quiet impression, while dull grade is positioned between gloss and matt prints because of the low sheet gloss and high print gloss. Demands for matt prints have recently increased because printed characters on matt prints are easier to read than those on conventional gloss prints. High print gloss is one of the goals in all of gloss grade, dull grade and matt grade, though they have different glosses before printing.

A method for producing high-quality coated papers by film transfer coating is to increase the coating weight. One means for increasing the coating weight by film transfer coating is to improve the transferability of the coating color on the applicator roll onto the base paper. A technique for improving the transferability of the coating color on the applicator roll onto the base paper is to decrease the water retention of the coating color to help the coating color to penetrate (therefore to be transferred to) the base paper when the applicator roll comes into contact with the base paper. However, it is difficult to change to a considerable degree the absolute coating weight and to increase the coating weight to achieve the intended purpose that coated papers with excellent printability are obtained, though the transferability of the coating color onto the base paper is relatively improved.

Another means for increasing the coating weight by film transfer coating is to increase the absolute weight of the coating color on the applicator roll to increase the absolute weight transferred to the base paper. When a standard coating color is used to increase the coating color on the applicator roll, not only the absolute weight transferred to the base paper but also the absolute weight remaining untransferred on the applicator roll increases because of the limitation of the transfer efficiency onto the base paper. A part of the coating color remaining untransferred on the applicator roll scatters in the form of mist, whereby a considerable amount of the coating color remaining untransferred on the applicator roll causes the absolute weight of mist to be increased and leads to problems during the preparation especially at higher coating speeds.

A typical means for increasing the absolute weight of the coating color on the applicator roll is to increase the solid content of the coating color, but the viscosity of the coating color also increases when the solid content of the coating color is increased. Transfer roll coaters used in film transfer coating are designed in such a manner that a coating color is supplied onto a nip between an inner roll outside an applicator roll and an outer roll further outside. If the viscosity of the coating color is high, the coating color splashes (hereinafter referred to as ‘boiling’), thereby causing serious problems in operation especially at higher coating speeds because of the continuous rotation of the inner roll and the outer roll.

One significant problem with coated papers for web offset printing is the occurrence of blistering during drying after printing has been carried out. Blistering is closely related to air permeability of the coated paper. If the air permeability is high, blisters are more likely to occur on inked-up prints. The coating weight is more difficult to increase by film transfer coating than by blade coating. In order to achieve good printability, therefore, it is necessary to improve the coatability on the base paper at a low coating weight. To improve the coverage of the base paper on the base paper, a coating color with high water retention is typically used. However, coating color with high water retention normally tend to have high viscosity, which invites boiling or other problems.

JPA 2000-256988 describes a coated paper for printing with good operability and excellent printability obtained by applying a coating color corresponding to a specific formula using the metered film transfer method. However, printability and other properties were found to be not sufficient in the above described coated paper for printing and problems such as mist and boiling occurred.

Thus, it was difficult to obtain coated papers for offset printing with good coating runnability during coating by the film transfer method as well as excellent printability and desired properties. Moreover, it was especially difficult to obtain by simply applying conventional techniques, coated papers for web offset printing with good printability such as those which are blister resistant. It was also difficult to obtain coated papers for gravure printing with excellent operability and desired printability.

In view of the situation above, an object of the present invention is to provide a method for producing a coated paper for printing having good coating runnability by the film transfer method as well as excellent printability for offset printing and gravure printing, and the resulting coated paper.

Another object of the present invention is to provide a method for producing a coated paper for web offset printing having good coating runnability by the film transfer method as well as excellent printability and is blister resistant.

### DISCLOSURE OF THE INVENTION

As a result of careful studies of the problems described above, we found that coated papers for printing with excellent offset printability or gravure printability can be obtained in a method for producing a coated paper for printing by applying a coating color containing a pigment and an adhesive on a base paper when the coating color containing 0.1 parts by weight or more and less than 2.0 parts by weight of polyvinyl alcohol (PVA) per 100 parts by weight of the pigment is applied by the film transfer method so that the problems above can be solved, and finally we accomplished the present invention.

We also found that coated papers for web offset printing with good coating runnability and excellent printability such as being blister resistant can be obtained in a method for producing a coated paper for web offset printing by applying a coating color containing a pigment and an adhesive on a base paper when the coating color containing 0.1 parts by weight or more and less than 2.0 parts by weight of polyvinyl alcohol (PVA) and less than 2.0 parts by weight of a starch per 100 parts by weight of the pigment is applied by the film transfer method so that the problems described above can be overcome.

In the present invention, it is important to add 0.1 parts by weight or more and less than 2.0 parts by weight of polyvinyl alcohol (PVA) per 100 parts by weight of the pigment for coating. PVA has been used as an adhesive for coating pigments (hereinafter referred to as binder) in the field of paper coating but limited to the use in the field of special papers and information papers typically having a low coating weight because of the low viscosity of the coating color as compared with those containing typical binders for coated papers such as styrene-butadiene latexes (hereinafter referred to as SB latexes) or various starches. When more than 2.0 parts by weight of PVA is added, the viscosity of the coating color exceeds a typical range of coating viscosity so that the viscosity should be lowered by decreasing the solid content of the coating color. A means for increasing the coating weight using a low-density coating color by film transfer coating is to increase the absolute weight of the coating color on the applicator roll to increase the absolute weight transferred to the base paper. When a low solids coating color is used to increase the coating weight on the applicator roll, however, not only the absolute weight transferred to the base paper but also the absolute weight remaining untransferred on the applicator roll increases because of the limitation of the transfer efficiency onto the base paper. A part of the coating color remaining untransferred on the applicator roll scatters in the form of mist, whereby a considerable amount of the coating color remaining untransferred on the applicator roll causes the absolute weight of mist to be increased and leads to problems during the preparation. If the viscosity of the coating color is high, boiling also occurs between the inner roll and the outer roll of the transfer roll coater used in the film transfer coating method, thus causing serious problems in operation. Sheet gloss and ink density are also poor.

If less than 0.1 parts by weight of PVA is added, it is difficult to solve the problems of the prior art because the transferability of the coating color is not sufficiently improved and the sheet gloss and ink density are poor and the operability is affected by boiling or mist.

Thus, we found that the transferability of the coating color to the base paper is dramatically improved and excellent sheet gloss and ink density and good coating runnability are achieved by adding 0.1 parts by weight or more and less than 2.0 parts by weight of PVA as an auxiliary rather than a binder. In view of the balance between the transferability of the coating color and the viscosity of the coating color, the most preferred amount of PVA to be added is 0.1-1.0 parts by weight. The polymerization degree of PVA is preferably 500-3000.

The coating color produced is applied in one or more layers on both sides of a base paper simultaneously or sequentially by the film transfer method typically using a transfer roll coater or a metering size press. The coating weight per side is preferably 7 g/m² or more, more preferably 10 g/m² or more, especially 12 g/m² or more. If the coating weight per side is less than 7 g/m², it is difficult to obtain sufficient ink density because of the poor coverage of the base paper. Coated papers for gravure printing have significant missing dots, but good coating ruunability and excellent printability are obtained without the problems of boiling or mist occurring by the film transfer coating method even at a coating weight of 10 g/m² or more according to the present invention. Excellent results are obtained especially using a transfer roll coater.

In the coated papers for web offset printing of the present invention, it is important to add less than 2 parts by weight of starches such as oxidized starches, cationic starches, urea phosphate-esterified starches, hydroxyethyl starches and dextrin as adhesives. Starches are adhesives having high water retention and are often used for film transfer coating. However, starches must be added in larger amounts because of the low adhesion strength per unit weight as compared with SB latexes or the like. Coated papers containing more than 2 parts by weight of starches are not suitable for web offset printing because of high resistance to air permeation and low blister resistance. When the coating weight per side is 7 g/m² or more, this tendency becomes marked especially in the case where the paper is treated in a supercalender or soft nip calender or the like after coating. In order to maintain a low resistance to air permeation, the total amount of the adhesive should preferably be 18 parts by weight or less, more preferably 16 parts by weight or less.

### PREFERRED EMBODIMENTS OF THE INVENTION

The pigment used in the coating color of the present invention is not specifically limited, and a plurality of pigments can be used in combination so far as each object of the invention is not affected. Conventional pigments for coated papers can be used, e.g. inorganic pigments such as kaolin, clay, ground calcium carbonate, precipitated calcium carbonate, talc, titanium dioxide, barium sulfate, calcium sulfate, zinc oxide, silicic acid, silicates, colloidal silica and satin white; and organic pigments such as plastic pigments, and these pigments can be used alone or in combination of two or more as appropriate. Preferably, 75 parts by weight or more of kaolin is added per 100 parts by weight of the pigment to improve printability.

One or more conventional adhesives for coated papers can be appropriately selected, e.g. synthetic adhesives such as styrene-butadiene copolymers, styrene-acrylic copolymers, ethylene-vinyl acetate copolymers, butadiene-methyl methacrylate copolymers, vinyl acetate-butyl acrylate copolymers, or maleic anhydride copolymers and acrylic-methyl methacrylate copolymers; proteins such as casein, soybean protein and synthetic proteins; starches such as oxidized starches, cationic starches, urea phosphate-esterified starches, etherified starches such as hydroxyethyl starches and dextrin; and cellulose derivatives such as carboxymethylcellulose, hydroxymethylcellulose and hydroxyethylcellulose. These adhesives are used in a range of about 5-50 parts by weight, more preferably 10-30 parts by weight per 100 parts by weight of the pigment. However, starches are used for coated papers for gravure printing in an amount of 5 parts by weight or less, more preferably less than 3 parts by weight per 100 parts by weight of the pigment. Coated papers containing 5 parts by weight or more of starches are not preferred for gravure printing because the coating layers become hard and have insufficient cushioning performance and many missing dots. The amount of the starches to be added is also limited in terms of operability, because coating color containing high proportions of starches have high water retention to readily generate mist during film transfer coating.

In addition to PVA, the coating color of the present invention may contain various common auxiliaries such as dispersants, thickeners, water-retaining agents, antifoamers and waterproof agents. The content of solids in the coating color of the present invention should preferably be adjusted to 40-70% by weight, more preferably 45-65% by weight to achieve good coatability and printability.

The base paper to be coated may be appropriately a paper or paperboard used for normal coated papers having a basis weight of about 25-400 g/m². The base paper may be made by any process for making acidic, neutral or basic papers using a Fourdrinier paper machine including a top wire former, a cylinder paper machine, a board machine combining both or a Yankee dryer machine or the like and naturally includes wood-containing base paper and base paper containing recycled pulp. Base papers precoated with starches or polyvinyl alcohol or precoated with a coating color containing a pigment and an adhesive in one or more layers using a size press, bill blade, gate roll coater, premetering size press or the like may also be used.

The pulp from which the base paper is formed may be chemical pulp (bleached or unbleached softwood kraft pulp, bleached or unbleached hardwood kraft pulp, etc.), mechanical pulp (ground pulp, thermomechanical pulp, chemithermomechanical pulp, etc.), deinked pulp (recycled pulp) alone or in admixture at any proportions.

The pH of the base paper may be acidic or neutral or alkaline. The types of paper fillers are not specifically limited but may be any known fillers such as hydrated silica, white carbon, talc, kaolin, clay, calcium carbonate, titanium oxide or synthetic resin fillers. If desired, aluminum sulfate, sizing agents, paper strength enhancers, yield improvers, colorants, dyes, antifoaming agents or the like may also be contained.

In the present invention, the thus prepared coating color is applied in one or more layers on both sides simultaneously or sequentially by the film transfer method typically using a transfer roll coater or a metering size press. When a transfer roll coater is used, the peripheral speed ratio of the inner roll and outer roll to the applicator roll is preferably 50-95%. In the present invention, problems of misting and boiling can be avoided especially at high coating speed of 1000 m/min or more, and more preferably at 1100 m/min or more.

Wet coating layers are dried by using e.g. a steam superheater cylinder, hot air dryer, gas heater dryer, electric heater dryer, infrared heater dryer, microwave heater dryer or the like alone or in combination.

The coated paper dried as above is used directly or after smoothing in a supercalender, hot soft nip calendar or the like. The effect of the present invention is excellent in coated papers having a basis weight of 25-120 g/m². The effect is also excellent in coated papers for web offset printing especially having a sheet gloss of 50% or more.

### EXAMPLES

The following examples further illustrate the present invention without, however, limiting the invention thereto as a matter of course. Unless otherwise specified, parts and % in the examples mean % by weight. Coating color and the resulting coated papers for printing were tested by the following evaluation methods.

<Evaluation methods>

(1) Sheet gloss: Determined according to JIS P 8142.

(2a) Print gloss of coated papers for offset printing: Printing was performed using a Toshiba web offset press (4 colors) with a B-size portrait format plate and an offset printing ink (LEOECOO M from TOYO INK MFG.) at a printing speed of 500 rpm, and the surface of the resulting print (solid print in 4 colors) was tested according to JIS P 8142.

(2b) Print gloss of coated papers for gravure printing: Printing was performed using a single color gravure printing press as used in the Printing Bureau of the Ministry of Finance of the Japanese Government at a printing speed of 40 m/min and a printing pressure of 10 kgf/cm, and the surface of the resulting print was tested according to JIS P 8142.

(3) Ink density: Printing was performed using a Toshiba offset rotary press (4 colors) with a B-size portrait format plate and an offset printing ink (LEOECOO M from TOYO INK MFG.) at a printing speed of 500 rpm, and the ink density of the resulting print (solid print in cyan simply) was visually evaluated according to the following 4-rank standard. ⊚: excellent, ◯: good, Δ: slightly poor, ×: poor.

(4) Misting: The amount of misting during film transfer coating was evaluated as described in JPA HEI 11-333353 and evaluated according to the following standard. ⊚:very good, ◯: good, Δ: slightly poor, 33 : poor.

(5) Transferability of the coating color: The transferability of the coating color during film transfer coating was evaluated on the basis of the relationship between the amount of the coating color supplied to the coating application and the coated weight and evaluated according to the following standard. ⊚:very good, ◯: good, Δ: slightly poor, ×: poor.

(6) Boiling: Boiling level between the inner roll and the outer roll of the transfer roll coater was visually evaluated according to the following standard. ⊚:very good, ◯: good, Δ: slightly poor, ×: poor.

(7) Blister resistance: Evaluated on the basis of the temperature at which blister occurred in 4-color overprints (ink density: black 1.80, cyan 1.50, magenta 1.45, yellow 1.05, as determined by X-Rite 408 from X-Rite) during web offset printing.

Coated papers for gravure printing were further evaluated as follows.

(8) Missing dots: The degree of missing dots in the coated paper after single color gravure printing as described above was visually evaluated according to the following standard. ⊚:very good, ◯: good, Δ: slightly poor, ×: poor.

### EXAMPLES AND COMPARATIVE EXAMPLES OF COATED PAPERS FOR OFFSET PRINTING

### Example 1

A pigment consisting of 26 parts of fine clay (DB-GRAZE from IMERYS), 26 parts of US #1 clay (DB-PRIME from IMERYS), 26 parts of US #2 clay (HS-H from J. M. HUBER) and 22 parts of fine-ground calcium carbonate (FMT-90 from FIMATEC) was dispersed with sodium polyacrylate as a dispersant in an amount of 0.2 parts on the basis of the pigment in a Cellier mixer to prepare a pigment slurry having a solids content of 70%. To the thus obtained pigment slurry were added 16 parts of styrene-butadiene latex (glass transition temperature 20° C.), 4 parts of hydroxyethyl starch and 0.5 parts of PVA (PVA117 from KURARAY) and water was further added to give a coating color having a solids content of 60%. Wood-containing base paper having a basis weight of 62 g/m² was coated with the coating color on both sides at a coating weight of 12.0 g/m² as solids per side using a transfer roll coater at a coating speed of 1200 m/min and dried to a moisture content of 5.5% in the paper. The peripheral speed ratio of applicator roll: inner roll: outer roll of the transfer roll coater was constant at 100:70:70 and the pressure between rolls was also constant and the coating weight was controlled by changing the solid content.

Then, the paper was treated in a soft nip calender with 2 nips at a roll temperature of 70° C., a linear calendar pressure of 15 kg/cm and a paper feed speed of 1200 m/min to give a coated paper for offset printing.

### Example 2

A coated paper for offset printing was obtained by the same procedure as in Example 1 except that both sides were coated at a coating weight of 14 g/m² as solids per side.

### Example 3

A coated paper for offset printing was obtained by the same procedure as in Example 1 except that both sides were coated at a coating weight of 7.5 g/m² as solids per side.

### Example 4

A coated paper for offset printing was obtained by the same procedure as in Example 1 except that 1.5 parts of PVA was added.

### Example 5

A coated paper for offset printing was obtained by the same procedure as in Example 1 except that both sides were coated at a coating weight of 6.5 g/m² as solids per side.

### Example 6

A coated paper for offset printing was obtained by the same procedure as in Example 1 except that the pigment consisted of 25 parts of US #1 clay (DB-PRIME from IMERYS), 25 parts of US #2 clay (HS-H from J. M. HUBER), 25 parts of fine-ground calcium carbonate (FMT-90 from FIMATEC) and 25 parts of coarse-ground calcium carbonate (FMT-75 from FIMATEC).

### Comparative Example 1

A coated paper for offset printing was obtained by the same procedure as in Example 1 except that 0.05 parts of PVA was added.

### Comparative Example 2

A coated paper for offset printing was obtained by the same procedure as in Example 1 except that 2.5 parts of PVA was added.

The results are shown in Table 1.

TABLE 1

| | Sheet | Print | Ink | | Transfer- | |
|---|---|---|---|---|---|---|
| | gloss % | gloss % | density | Mistng | ability | Boiling |
| Example 1 | 40 | 70 | ⊚ | ⊚ | ⊚ | ⊚ |
| Example 2 | 45 | 77 | ⊚ | ⊚ | ⊚ | ⊚ |
| Example 3 | 35 | 60 | ⊚ | ⊚ | ⊚ | ⊚ |
| Example 4 | 40 | 65 | ⊚ | ◯ | ⊚ | ◯ |
| Example 5 | 30 | 55 | ◯ | ⊚ | ⊚ | ⊚ |
| Example 6 | 25 | 53 | ⊚ | ⊚ | ⊚ | ⊚ |
| Compar- | 30 | 55 | Δ | X | X | Δ |
| ative | | | | | | |
| example 1 | | | | | | |
| Compar- | 28 | 53 | Δ | X | ⊚ | X |
| ative | | | | | | |
| example 2 | | | | | | |

### Example 7

A pigment consisting of 26 parts of fine-grained clay (DB-GRAZE from IMERYS), 26 parts of US #1 clay (DB-PRIME from IMERYS), 26 parts of US #2 clay (HS-H from J. M. HUBER) and 22 parts of fine-ground calcium carbonate (FMT-90 from FIMATEC) was dispersed with sodium polyacrylate as a dispersant in an amount of 0.2 parts on the basis of the pigment in a Cellier mixer to prepare a pigment slurry having a solids content of 70%. To the thus obtained pigment slurry were added 16 parts of styrene-butadiene latex (glass transition temperature 20° C.) and 0.5 parts of PVA (PVA117 from KURARAY) and water was further added to give a coating color having a solids content of 60%. Wood-containing base paper having a basis weight of 62 g/m² was coated with the coating color on both sides at a coating weight of 12.0 g/m² as solids using a transfer roll coater at a coating speed of 1200 m/min and dried to a moisture content of 5.5% in the paper. The peripheral speed ratio of applicator roll: inner roll: outer roll of the transfer roll coater was constant at 100:70:70 and the pressure between rolls was also constant and the coating weight was controlled by changing the solids content.

Then, the paper was treated in a soft nip calender with 2 nips at a roll temperature of 130° C., a linear calendar pressure of 200 kg/cm and a paper feed speed of 400 m/min to give a coated paper for web offset printing.

### Example 8

A coated paper for web offset printing was obtained by the same procedure as in Example 7 except that both sides were coated at a coating weight of 14 g/m² as solids per side.

### Example 9

A coated paper for web offset printing was obtained by the same procedure as in Example 7 except that both sides were coated at a coating weight of 7.5 g/m² as solids per side.

### Example 10

A coated paper for web offset printing was obtained by the same procedure as in Example 7 except that 1.5 parts of PVA was added.

### Example 11

A coated paper for web offset printing was obtained by the same procedure as in Example 7 except that both sides were coated at a coating weight of 6.5 g/m² as solids per side.

### Example 12

A coated paper for web offset printing was obtained by the same procedure as in Example 7 except that the adhesive consisted of 15 parts of styrene-butadiene latex (glass transition temperature 20° C.) and 1.5 parts of hydroxyethyl starch.

### Comparative Example 3

A coated paper for offset printing was obtained by the same procedure as in Example 7 except that 0.05 parts of PVA was added.

### Comparative Example 4

A coated paper for offset printing was obtained by the same procedure as in Example 7 except that 2.5 parts of PVA was added.

### Comparative Example 5

A coated paper for offset printing was obtained by the same procedure as in Example 7 except that 4 parts of hydroxyethyl starch was added.

The results are shown in Table 2.

TABLE 2

| | Sheet | Print | Ink | | | | Blister |
|---|---|---|---|---|---|---|---|
| | gloss % | gloss % | density | Misting | Transferability | Boiling | ° C. |
| Example 7 | 60 | 75 | ⊚ | ⊚ | ⊚ | ⊚ | 140 |
| Example 8 | 65 | 81 | ⊚ | ⊚ | ⊚ | ⊚ | 140 |
| Example 9 | 55 | 65 | ⊚ | ⊚ | ⊚ | ⊚ | 150 |
| Example 10 | 60 | 70 | ⊚ | ◯ | ⊚ | ◯ | 140 |
| Example 11 | 50 | 60 | ◯ | ⊚ | ⊚ | ⊚ | 150 |
| | | | | | | | or more |
| Example 12 | 59 | 75 | ⊚ | ⊚ | ⊚ | ⊚ | 130 |
| Comparative | 50 | 60 | Δ | X | X | Δ | 140 |
| example 3 | | | | | | | |
| Comparative | 48 | 58 | Δ | X | ⊚ | X | 140 |
| example 4 | | | | | | | |
| Comparative | 55 | 70 | ⊚ | ⊚ | ⊚ | ⊚ | 100 |
| example 5 | | | | | | | |

### EXAMPLES AND COMPARATIVE EXAMPLES OF COATED PAPERS FOR GRAVURE PRINTING

### Example 13

A pigment consisting of 26 parts of fine-ground clay (DB-GRAZE from IMERYS), 26 parts of US #1 clay (DB-PRIME from IMERYS), 26 parts of US #2 clay (HS-H from J. M. HUBER) and 22 parts of fine-ground calcium carbonate (FMT-90 from FIMATEC) was dispersed with sodium polyacrylate as a dispersant in an amount of 0.2 parts on the basis of the pigment in a Cellier mixer to prepare a pigment slurry having a solids content of 70%. To the thus obtained pigment slurry were added 8 parts of styrene-butadiene latex (glass transition temperature −10° C.), 1 parts of hydroxyethyl starch and 0.5 parts of PVA (PVA117 from KURARAY) and water was further added to give a coating color having a solids content of 60%. Wood-containing base paper having a basis weight 62 g/m² was coated with the coating color on both sides at a coating weight of 12.0 g/m² as solids using a transfer roll coater at a coating speed of 1200 m/min and dried to a moisture content of 5.5% in the paper. The peripheral speed ratio of applicator roll: inner roll: outer roll of the transfer roll coater was constant at 100:70:70 and the pressure between rolls was also constant and the coating weight was controlled by changing the solids content.

Then, the paper was treated in a soft nip calender with 2 nips at a roll temperature of 70° C., a linear calendar pressure of 200 kg/cm and a paper feed speed of 10 m/min to give a coated paper.

### Example 14

A coated paper for gravure printing was obtained by the same procedure as in Example 13 except that both sides were coated at a coating weight of 14 g/m² as solids per side.

### Example 15

A coated paper for gravure printing was obtained by the same procedure as in Example 13 except that both sides were coated at a coating weight of 7.5 g/m² as solids per side.

### Example 16

A coated paper for gravure printing was obtained by the same procedure as in Example 13 except that 1.5 parts of PVA was added.

### Example 17

A coated paper for gravure printing was obtained by the same procedure as in Example 13 except that both sides were coated at a coating weight of 6.5 g/m² as solids per side.

### Example 18

A coated paper for gravure printing was obtained by the same procedure as in Example 13 except that the pigment consisted of 25 parts of US #1 clay (DB-PRIME from IMERYS), 25 parts of US #2 clay (HS-H from J. M. HUBER), 25 parts of fine-ground calcium carbonate (FMT-90 from FIMATEC) and 25 parts of coarse-ground calcium carbonate (FMT-75 from FIMATEC).

### Comparative Example 6

A coated paper for gravure printing was obtained by the same procedure as in Example 13 except that 0.05 parts of PVA was added.

### Comparative Example 7

A coated paper for gravure printing was obtained by the same procedure as in Example 13 except that 2.5 parts of PVA was added.

The results are shown in Table 3.

TABLE 3

| | Sheet | Print | Missing | Mist | Transfer- | Boil- |
|---|---|---|---|---|---|---|
| | gloss % | gloss % | dots | generation | ability | ing |
| Example 13 | 60 | 85 | ⊚ | ⊚ | ⊚ | ⊚ |
| Example 14 | 65 | 89 | ⊚ | ⊚ | ⊚ | ⊚ |
| Example 15 | 55 | 75 | ⊚ | ⊚ | ⊚ | ⊚ |
| Example 16 | 60 | 80 | ⊚ | ◯ | ⊚ | ◯ |
| Example 17 | 50 | 70 | ◯ | ⊚ | ⊚ | ⊚ |
| Example 18 | 45 | 68 | ⊚ | ⊚ | ⊚ | ⊚ |
| Comparative | 50 | 70 | Δ | X | X | Δ |
| example 6 | | | | | | |
| Comparative | 48 | 68 | Δ | X | ⊚ | X |
| example 7 | | | | | | |

### ADVANTAGES OF THE INVENTION

According to the present invention, coated papers for printing such as coated papers for offset printing and coated papers for gravure printing with good coating ruunability during film transfer coating, good ink density or other properties, and excellent blister resistance (in the case of coated papers for web offset printing) or decreased missing dots (in the case of coated papers for gravure printing) as well as excellent printability can be efficiently obtained.

1. (canceled)

2. A method for producing a coated paper for printing by applying a coating color containing a pigment and an adhesive on a base paper, characterized in that said coating color contains 0.1 parts by weight or more and less than 2.0 parts by weight of polyvinyl alcohol (PVA) per 100 parts by weight of the pigment and is applied by a film transfer method with a coating weight per side is of 7 g/m² or more.

3. The method for producing a coated paper for offset printing according to claim 2.

4. The method for producing a coated paper for gravure printing according to claim 2.

5. A method for producing a coated paper for web offset printing by applying by a film transfer method a coating color containing a pigment and an adhesive on a base paper at a coating weight per side of said paper, wherein the coating color comprises:
0.1 to less than 2.0 parts by weight of the pigment of polyvinyl alcohol as an auxiliary, and
less than 2.0 parts by weight of a starch as an adhesive per 100 parts by weight of the pigment

6. The method for producing a coated paper for web offset printing according to claim 5 characterized in that 18 parts by weight or less of the adhesive is added per 100 parts by weight of the pigment.

7. The method for producing a coated paper for web offset printing according to claim 5 characterized in that the coating weight per side is 7 g/m² or more.

8. The method for producing a coated paper for web offset printing according to claim 5 characterized in that a transfer roll coater is used in the film transfer method.

9. A coated paper for printing produced by the method according to claim 5.
